(19) United States
(12) Patent Application Publication
(10) Pub. No.: US 2011/0283335 A1
(43) Pub. Date: Nov. 17, 2011

(54) HANDLING PRIVACY PREFERENCES AND POLICIES THROUGH LOGIC LANGUAGE

(75) Inventors: Laurent Bussard, Illkirch (FR); Moritz Y. Becker, Cambridge (GB)

(73) Assignee: MICROSOFT CORPORATION, Redmond, WA (US)

(21) Appl. No.: 12/779,029

(22) Filed: May 12, 2010

(51) Int. Cl. G06F 21/00; G06F 17/30

(52) U.S. Cl. 726/1; 707/769; 707/E17.014

(57) ABSTRACT

A logic language model for handling of personal data by specifying users' preferences on how their personal data should be treated by data-collecting services and the services' policies on how they will treat collected data is provided. Preferences and policies are specified in terms of granted rights and required obligations, expressed as declarative assertions and queries. Query evaluation is formalized by a proof system for verifying whether a policy satisfies a preference is defined.

### BACKGROUND

Businesses have strong economic incentives to aggregate customers' personal data for transactions over the Internet. However, studies show that the amount of personal information collected by commercial websites is actually decreasing. One reason for this decrease is increased pressure from regulators with regard to privacy and data protection. The European Union's privacy directive 95/46/EC, the Health Insurance Portability and Accountability Act (HIPAA, enacted 1996), Gramm-Leach-Bliley Act (enacted 1999) for the financial sector, and the Children's Online Privacy Protection Act (COPPA, enacted 1998) are examples of regulations on handling of personal information. Moreover, consumers' increased concern over online privacy has an effect on which companies users are willing to do business with. Publicly claiming to collect less personal information may thus be seen as a competitive advantage.

While attempts to address privacy protection and security concerns of users have been made in a variety of ways, some of those provide only service-side policies leaving it to users to parse those policies. Other approaches define lists of hierarchies of data-categories, user-categories, purposes, sets of (privacy) actions, obligations, and conditions. These elements are then used to formulate privacy authorization rules that allow or deny actions on data-categories by user-categories for certain purposes under certain conditions while mandating certain obligations. None of these mechanisms provide an efficient and comprehensive solution for online service related privacy concerns. Moreover, existing mechanisms lack formalism to analyze preferences and policies.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to handling of personal data through a language for specifying both users' preferences on how their personal data should be treated by data-collecting services, and the services' policies on how they will treat collected data. Preferences and policies may be specified in terms of granted rights and required obligations, expressed as declarative assertions and queries. Query evaluation may be formalized by a proof system for verifying whether a policy satisfies a preference is defined.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 is a conceptual diagram illustrating an example environment where personal data may be exchanged between a user and a service subject to service policies and user preferences;

FIG. 2 illustrates how user preferences and corresponding service policies may be exchanged in a system according to embodiments;

FIG. 3 is an action diagram illustrating actions and interactions between a user and services implementing personal data handling according to embodiments;

FIG. 4 is a networked environment, where a system according to embodiments may be implemented;

FIG. 5 is a block diagram of an example computing operating environment, where embodiments may be implemented; and

FIG. 6 illustrates a logic flow diagram for handling personal data based on user preferences and service policies according to embodiments.

### DETAILED DESCRIPTION

As briefly described above, handling of personal data by data collection services may be managed through a language for specifying users' preferences on how their personal data should be treated by data-collecting services and the services' policies on how they will treat collected data. Preferences and policies may be specified in terms of granted rights and required obligations, expressed as declarative assertions and queries. Query evaluation may be formalized by a proof system for verifying whether a policy satisfies a preference is defined. In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or a compact disk, and comparable media.

Throughout this specification, references are made to services. A service as used herein describes any networked/on line application(s) that may receive a user's personal information as part of its regular operations and process/store/forward that information. Such application(s) may be executed on a single computing device, on multiple computing devices in a distributed manner, and so on. Embodiments may also be implemented in a hosted service executed over a plurality of servers or comparable systems. The term “server” generally refers to a computing device executing one or more software programs typically in a networked environment. However, a server may also be implemented as a virtual server (software programs) executed on one or more computing devices viewed as a server on the network. More detail on these technologies and example operations is provided below. Moreover, embodiments are not limited to personal data. Systems for handling preferences and policies may be implemented in systems for right management and/or usage control using the principles described herein.

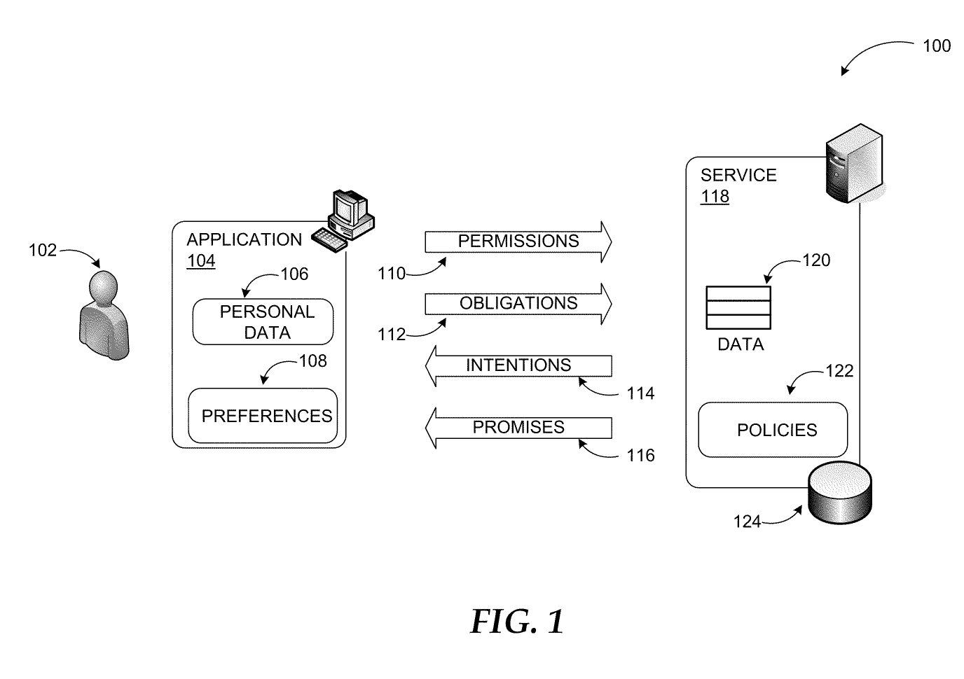

Referring to FIG. 1, conceptual diagram 100 illustrates an example environment where personal data may be exchanged between a user and a service subject to service policies and user preferences. Privacy policy of a data collection service may specify the type of information that is collected and stored by the service (e-mail address, name, etc.), how collected data is used (personalization, advertisement, etc.), whether collected data is shared with third parties, how long the information is stored, whether the user can access stored data, and other parameters. On the other hand, a user's preferences may indicate which data may be collected, store, and/or shared; if data is to be stored, for how long; for which purposes the data may be used, and comparable rights and obligations.

In a typical online environment, more than one service may be involved in handling user information. Thus, the service collecting user data may forward a portion of the data to other services. Therefore, limited or overly complicated systems of comparing user preferences to service policies may not provide a desirable experience to users.

A system according to some embodiments is directed to processing the data-handling preferences and policies expressed as assertions and queries. Such a system may rely on and extend an existing language with a formal semantics, such as SecPAL or S4P. The security policy language's key features such as its syntactic and semantic format, policy expressiveness, and execution efficiency may be inherited and expanded upon. The syntax of the example SecPAL (or S4P) is close to natural language, and the semantics consists of few deduction rules. The language can express many common policy idioms using constraints, controlled delegation, recursive predicates, and negated queries. Because the language has a formal semantics, it is possible to reason about preferences and policies in order to verify properties and find missing assertions.

As shown in diagram 100, user 102 may interact with service 118 through application 104 executed on a client device (e.g. a desktop computer, a laptop computer, a handheld computer, a smart phone, a vehicle mount computer, and the like). Application 104 may be a function-specific application or a generic one like a browsing application. The user's personal data 106 such as name, date of birth, email addresses, and credit card numbers may be stored by application 104 or provided by the user 102 when requested. Additionally, application 104 may also store or have access to the user's preferences 108 associated with how the user wants their personal data 106 to be handled by services.

Service 118 may be data collection service in conjunction with one or more online service providers (e.g. travel services, financial services, sales services, etc.). Service 118 may gather, store, and process data 120 including personal data from a number of users. The service's data handling policies 122 may define various aspects of how the personal data is to be handled. Policies 122 and data 120 may be stored in one or more data stores such as data store 124 accessible by the service 118.

In a system according to embodiments, user 102 may provide their preferences as permissions 110 and obligations 112 to the service. Permissions 110 may define an upper boundary on how the service can use the user's personal data, while obligations 112 may define a lower boundary for future behaviors. Service 118 may submit their policies to user 102 as intentions 114, which define an upper bound on the service's own behavior, and promises 116, which define a lower bound on the service's own behavior. Furthermore, a logic language according to embodiments may express preferences and policies regarding data forwarding to third parties. This enables more control on data transfer. The language may also make it possible to express statements on data handling policies of another party in a separate administrative domain (i.e. outside the scope of the organization's service/website).

The data handling language described herein may be used with different settings ranging from purely service-driven scenarios to user-driven scenarios. In a service-driven scenario, the user gets a static policy describing how the service (and potential third parties) will handle his/her personal data. The user checks that his/her preferences match the policy and provide the personal data to the service. The service knows the static policy that must be enforced and ensures that no operation violating the policy can happen. The main advantages of such scenarios are simplicity and efficiency since the policy is evaluated once.

In more dynamic scenarios, the user may personalize policies to make sure that specific personal data is treated appropriately. In this case, part of the preferences has to be sent to the service with the personal data. Moreover, a service may collect personal data through different mechanisms with different policies (purpose, obligations, etc.) and store them together. As a result, it may be necessary to have policies associated to one or more personal data. Such policies are referred to as being attached to personal data as “sticky policies”. In this latter case, before using personal data, the service must check that it is allowed by relevant policies to do so. Flexibility has a computational cost that may be overwhelming when policy evaluation is required before any action on personal data. Grouping personal data with common policies as well as caching policy evaluation results may be used to improve performances when flexibility is necessary.

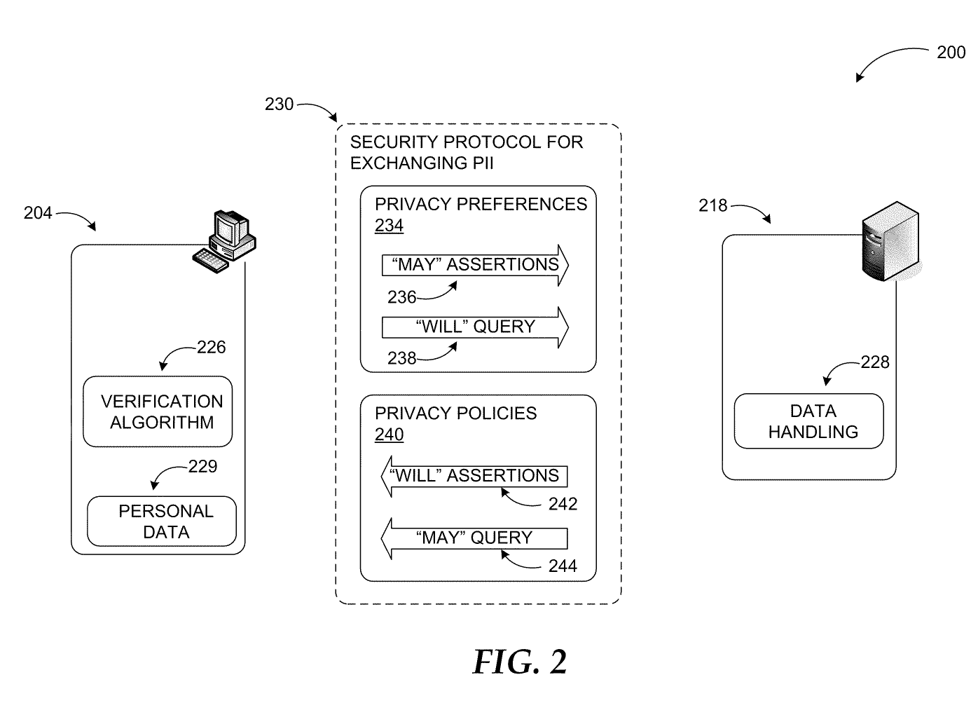

FIG. 2 illustrates how user preferences and corresponding service policies may be exchanged in a system according to embodiments. Diagram 200 shows a user's application 204 interacting with a service 218 through a security protocol 230 for exchanging personal data. Before the user sends their personal data 229, user may receive privacy policies 240 of the service 218 in form of will assertions 242 and may query 244. Verification algorithm 226 at the user's application 204 may then compare the privacy policies 240 to the user's privacy preferences 234, which may be in form of may assertions 236 and will query 238. User's application 204 may then send personal data 229 and, optionally, a sticky policy resulting from the privacy policies 240 and privacy preferences 234 to service 218.

Executing the verification algorithm user-side as shown in diagram 200 provides a more scalable architecture and reduces the risk of denial of service. This approach also limits a size of exchanged pieces of policies, and helps protect the privacy of the user. However, according to other embodiments, the verification may be performed service-side or by a third party and the user notified that their preferences are met by the service policies (if the user trusts the service or the third party to perform the verification). The matching process is independent of any protocols that may be used to exchange data and policies (HTTP, SOAP or REST web services, Metadata Exchange, and comparable ones).

In an example encounter between a user and a service, the service requests personal data from the user, and the user may agree or disagree to the disclosure. The user is unlikely to be willing to unconditionally share their personal data with any service, but may generally decide depending on the service's properties and its privacy policy, a document that details how the service is going to handle users' data. To automate this decision process, the policy may be written in a logic language such as S4P, a formal language that machines can interpret. Furthermore, the user may also have a document written in S4P, called preference, which specifies their requirements on the service's properties and on its policy for this encounter.

According to an example scenario, the service may be a travel reservation service eBooking, which wants to collect the user's email address. User's privacy preference for this application domain and relating to her email address may consist of five assertions and a query:

Pr:1 User says x may use Email for p if
x is a BookingSvc;
where pε{Confirm; News; Stats}

Pr:2 Alice says x may delete Email within t

Pr:3 Alice says x may send Email to y if
x is a BookingSvc;
y is a TrustedPartner
Pr:4 Alice says CA can say x is a y

Pr:5 Alice says x can say y is a TrustedPartner if
x is a BookingSvc

PrQ:6 Alice says (Svc) is a RegisteredSvc?̂∃t ((Svc) says (Svc) will delete
Email within t?̂t<30 days?

Assertions in a preference express what a service may, or is permitted to, do with the user's personal data (and are thus also called may-assertions). In other words, they specify an upper bound on a service's behaviors with respect to the personal data. There may be a predefined collection of personal data-relevant service behaviors, and a corresponding vocabulary for representing these behaviors. Example behaviors include “use Email for Stats”, “delete Email within 13 days”, and “send Email to eMarketing”, but they may also be more application-domain specific like “retain X-rays for at least 10 years” or “upload health data to fitness devices”.

Assertion Pr.1 allows booking services to use user's email address for sending confirmations and newsletters, and for statistical purposes. Pr.2 permits any data collector to delete her email address. Pr.3 allows booking services to forward her email address to trusted partners. Assertions Pr.4 and Pr.5 do not mention “may”, but are auxiliary assertions that use the can-say mechanism to express delegation of authority. In Pr.4, user delegates authority over “is a” facts to the certificate authority CA. So, if user gets hold of a CA-issued credential that says that someone “is a BookingSvc”, then she is also willing believe this fact and use it, for example, to satisfy the conditions in Pr.1, Pr.3 or Pr.5. Similarly, Pr.5 delegates authority over the “is a TrustedPartner” property to anyone whom she believes to be a booking service.

The second part of a preference in a system according to embodiments is a will-query, which specifies a lower bound on a service's properties and behaviors. In other words, it expresses obligations i.e. the behaviors that a service must exhibit. The will-query PrQ.6 specifies that services must be registered services, and they must delete her email address within a month. Following on the above discussed example, the service eBooking may have a policy consisting of three assertions and a query:

Pl:1 eBooking says eBooking will
delete Email within 15 days

Pl:2 CA says eBooking is a RegisteredSvc

Pl:3 CA says eBooking is a BookingSvc

PlQ:4 (Usr) says eBooking may
use Email for Confirm?̂
(Usr) says eBooking may
   use Email for Stats?̂
(Usr) says eBooking may
   delete Email within 15 days?

Assertions in a policy express what a service will certainly do, or promises to do, with the user's personal data (and are thus also called will-assertions). In other words, they specify a lower bound on a service's behaviors with respect to the personal data. In Pl.1, eBooking promises to delete email addresses within 15 days. Pl.2 and Pl.3 are auxiliary assertions contained in credentials issued by CA. The second part of any policy is a may-query, which specifies an upper bound on a service's behaviors. In other words, it expresses and advertises possible relevant behaviors of the service. PlQ.4 is a may-query in which the service declares that it may use email addresses for confirmation and statistical purposes, and that it may delete email addresses within 15 days. Hereby, eBooking implicitly states that it will not exhibit any other relevant behaviors towards the collected email address.

Given the user's preference and eBooking's policy above, should the user agree to the disclosure of her email address? This depends on whether the policy satisfies her preference. Checking that a policy satisfies a preference may include two steps. Firstly, every behavior declared as possible in the policy must be permitted by the preference. Therefore, verification algorithm 226 may check that the upper bound specified in the policy is contained in the upper bound specified in the preference. Secondly, every behavior declared as obligatory in the preference must be promised by the policy. Therefore, verification algorithm 226 may check that the lower bound specified in the preference is contained in the lower bound specified in the policy.

This duality may be reflected in the language. The upper bound on behaviors may be specified in the user preference 234 as a collection of may-assertions 236, whereas in the service policy 240, the upper bound may be specified as a may-query 244, because the corresponding possible behaviors should be a subset of the permitted behaviors. Intuitively, a service must ask for permission upfront for anything that it might do with a user's personal data in the future. Conversely, the lower bound may be specified in the user preference 234 in terms of a will-query 238, and in the policy 240 as a collection of will-assertions 242. Intuitively, a user asks (requires) the service to promise the obligatory behaviors and the service announces what obligatory behavior it is willing to promise.

Thus, verification algorithm 226 may check if the may-query in the policy and the will-query in the preference are both satisfied. In general, the queries are not satisfied by a single assertion but by a set of assertions. This is because assertions may have conditions that depend on other assertions, and authority over asserted facts may be delegated to other principals. This is why the queries may be evaluated against the union of the assertions in the policy and the preference.

As indicated in the example encounter between user and eBooking, the placeholders (Usr) and (Svc) in the preference and policy may be replaced dynamically by user and eBooking, respectively, and the user's will-query and eBooking's may-query may be evaluated against the union of all assertions. The first part of the will-query succeeds because of Pl.2 and Pr.4. The second part succeeds because of Pl.1. The may-query also succeeds because Pl.3 and Pr.4 together prove that eBooking is a booking service, and because of user's may-assertions Pr.1 and Pr.2.

Thus the policy satisfies the preference, so user agrees to the disclosure. As long as eBooking complies with its own policy, i.e. if it indeed deletes the email address within the next 15 days and uses it for no other purposes but confirmation and statistics, eBooking's behavior will also comply with user's preference.

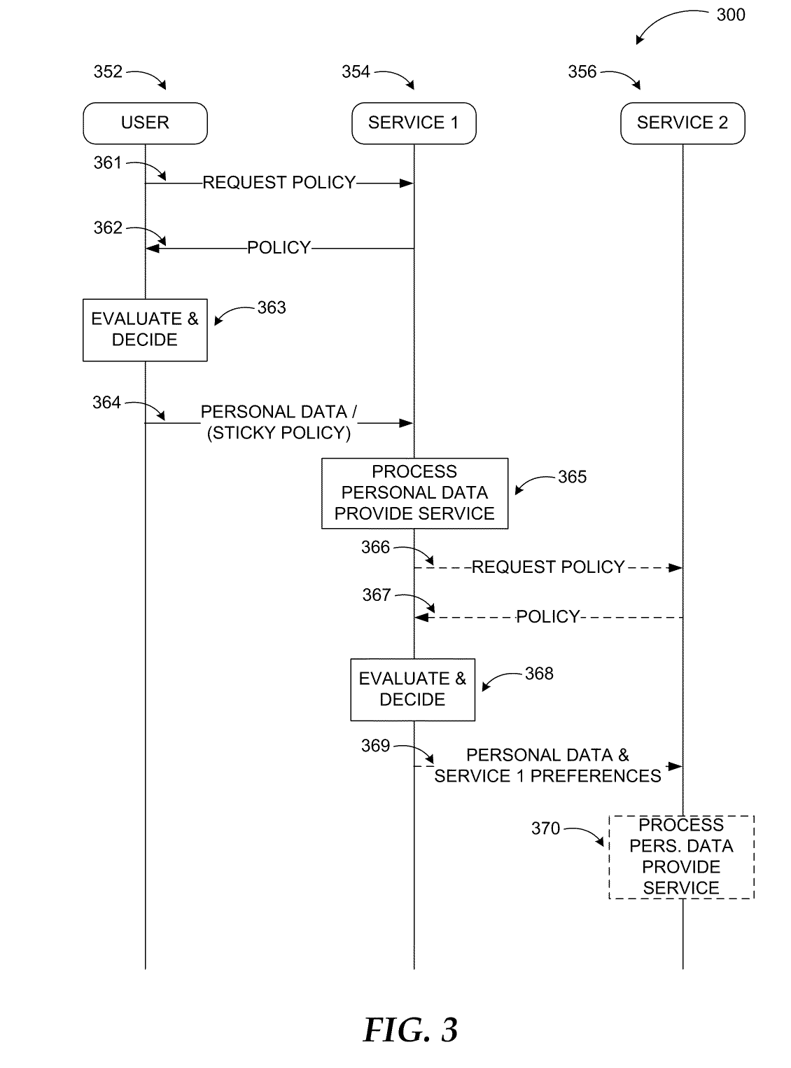

FIG. 3 is an action diagram illustrating actions and interactions between a user and services implementing personal data handling according to embodiments. Diagram 300 shows at a high level, how user 352, first service 354, and an optional second service 356 (representing third party services) may interact to establish matching policies and preferences before handling user's personal data. The number of services that may exchange personal data is not limited to two. Any number of services may receive and process personal data using the principles described herein.

At first exchange 361, user 354 may request its policy from first service 354, which may provide its policy (or policies) in form of will assertions and a may query to user 352 at exchange 362. User 352 may evaluate the policies of service 354 against his/her preferences employing queries and assertions, and decide (363) to send his/her personal data if there is a match. Upon receiving the personal data and optionally a sticky policy at exchange 364, first service 354 may process the personal data and provide requested service (365) (e.g. car rental, travel booking, library services, and comparable ones).

Optionally, a second service 356 may be needed to perform the user requested services (e.g. first service may be a travel booking service and second service may be an airline). Second service 356 may also be any third party that may receive user personal data from service 354 (e.g. a company that purchases personal data for marketing or statistical analysis purposes). To ensure compliance with the user's preferences and restrictions, first service 354 may request second service's policies at exchange 366 and receive the policies at exchange 367. First service may then evaluate the policies of the second service (368) against the user's preferences, which must allow the use of a second service to begin with, and against its own preferences (e.g. service 354 may have a more restrictive policy regarding use of personal data than the user's own preferences). If there is a match, first service 354 may provide the personal data and its preferences (based on the user's preferences) to second service 356 at exchange 369. Subsequently, second service 356 may process the personal data and provide a requested service (370) if it is a service providing third party. According to other examples, service 356 may simply consume the data for its own purposes (e.g. statistical analysis).

The exchanges discussed above are for illustration purposes and do not impose a limitation on embodiments. Indeed, embodiments may be implemented with additional or fewer interactions and in other orders. For example, the evaluation of the policies and obligations against the preferences and restrictions may be performed by the user, by the first service, by the second service, or by yet another party.

Returning to evaluation of policies and preferences, a user-service pair T=(U; S) is a pair of constants denoting the user (name) U (the personal data owner) and the service (name) S (the requester and potential recipient of the personal data) during an encounter. As mentioned above, a lower bound on service behaviors specified in users' preferences and the upper bound specified in services' policies may be expressed as a will-query and a may-query, respectively. In a logic language according to embodiments, a T-will-query, q_{w}, is a query in which no sub-query of the form (S says S will b?) occurs in the scope of a negation sign. Moreover, a T-may-query, qₘ, is a query in which no sub-query of the form (U says S may b?) occurs in a disjunction or in the scope of an existential quantifier or a negation sign.

The definition above syntactically restricts the query occurring in a policy or a preference to those that can be given an intuitive meaning in terms of an upper bound or a lower bound on behaviors, such that the formal query evaluation semantics matches this meaning. It should be noted that disjunction and, similarly, existential quantification may be allowed and have an obvious intuitive meaning within a will-query such as ∃t (S says S will delete Email within t?̂t<2 yr?). A may-query, however, represents an upper bound on a service's behavior, and disjunction may not make much sense in this context. If a service wanted to state that it may possibly use the user's email address for contact or for marketing (or possibly not at all), it may specify a conjunctive query like “U says S may use Email for Contact?̂U says S may use Email for Marketing?”. If this query is successful in the context of U's preference, the service is permitted to use the email address for contact, for marketing, or for both, or to not use it at all.

A query may be evaluated in the context of a set of assertions. A closed query evaluates to either true or false. According to one embodiment, the query evaluation semantics may be a slightly simplified variant of the one from SecPAL. A two-rule proof system may be defined that generates ground judgments of the form A├E says F:

$$\frac{\begin{matrix}〈 E says f if {f}_{1} , … , {f}_{n} where c 〉 ∈ ⊨ γ ( c ) \\ For all i ∈ \{ 1 , … , n \} \text{:} ⊢ E says γ ( {f}_{i} )\end{matrix}}{A ⊢ E says γ ( f )}$$

$$\frac{\begin{matrix}⊢ {E}_{1} says {E}_{2} can say F \\ ⊢ {E}_{2} says F\end{matrix}}{⊢ {E}_{1} says F}$$

The relation ├ deals with the case where the query is of the basic form (E says F?). This may be extended to all closed queries, by interpreting compound queries as formulas in first-order logic. Satisfaction between a policy and a preference is, thus, checked by evaluating the queries against the union of both the user's and the service's assertions.

In an encounter between U and S, U may provide a (U; S)-preference and S may provide a (U; S)-policy. According to other embodiments, preferences and policies may be written with placeholders that get instantiated when the encounter is initiated, with values that are specific to the encounter. In particular, the concrete syntax may include (Usr) and (Svc) that get instantiated with U and S, respectively.

Protocols for exchanging and handling personal data based on the notions of policies, preferences, satisfaction and compliance, may be formalized in terms of runs of a bundle of services. Each run is a linear sequence of states, where a state indicates which personal data a service currently possesses, and which policy and preference are associated with a collected personal data. In a run, each consecutive pair of states may be labeled by an event, such as an internal event without effect on the state (e.g. using an email address for notification) or a state-changing event (e.g. receiving personal data). The single service runs may be synchronized on send and receive events: whenever there is a send event, there must also be a corresponding receive event, and vice versa.

Different personal data handling protocols based on security languages may be employed, for example, one for exchanging personal data between users and services; one that allows services to modify their own policies; and one for transitive third party disclosure. The protocols may concretize abstract modeling approaches such as behavior mapping. The modeling techniques may also be applied to model other concrete behaviors such as data deletion or notification.

In some cases, a service may wish to alter its policy regarding personal data even after it has already collected the personal data. For example, a service may want to disclose the personal data to a previously unknown third party at some point after the original encounter, even though the behavior corresponding to the disclosure action was not declared in the may-assertions in its corresponding policy. Alternatively, the service may wish not to exhibit a behavior it had previously promised in the will-query of the policy. In strict terms, both cases represent compliance violations of the service's own original policy. However, it may be argued that such violations should be permitted as long as the new behaviors still comply with the user's original preference.

To accommodate such changes, the service may need to alter its policy in such a way that the new behaviors comply with the new policy. The service may then check if the new policy still satisfies the preference. If it does not, then the service must continue complying with the original policy; otherwise, the service may continue complying with the new policy guaranteeing that all policy changes result in policies that still satisfy the user's preference.

As mentioned previously, once personal data has been collected by a service, it may be sent on to third party services, which may in turn disclose it further. In most scenarios, this action of disclosing a user's personal data to a third party represents a relevant behavior that should be controlled within the personal data preference and policy. For example, the behavior of forwarding a user's email address to eMarketing may be expressed by the behavior atom (send Email to eMarketing). However, controlling the action of third party disclosure is not sufficient. The intended property of such a system is that every service that receives a user's personal data through a chain of disclosures also complies with the user's preference. To achieve this, a service S may only disclose personal data to a third party S* if (1) S's policy allows the disclosure, and (2) S*'s policy complies with U's preference. The trust model may dictate who performs this check (e.g. S).

The aforementioned placeholders (Usr) and (Svc) have a role in the context of forwarding personal data to further parties. If personal data may be forwarded along a chain of services, it is unreasonable to require that the original user preference contains specific references to all these services. Using the placeholders (Usr) and (Svc) effectively parameterizes preferences and policies by the current user-service pair. The placeholders are instantiated just before checking satisfaction. Also, service S may retain the original, uninstantiated preference along with the personal data, so that the preference can later be instantiated using T*=(U; S*) when S prepares to disclose the personal data to S.

While specific operations, grammar, syntax, and rules have been discussed in the example scenarios and matching of user preferences and service policies in conjunction with FIGS. 2 and 3, embodiments are not limited to those. Evaluation of data handling preferences and policies may be implemented employing other operations, grammar, syntax, rules, and so on, using the principles discussed herein.

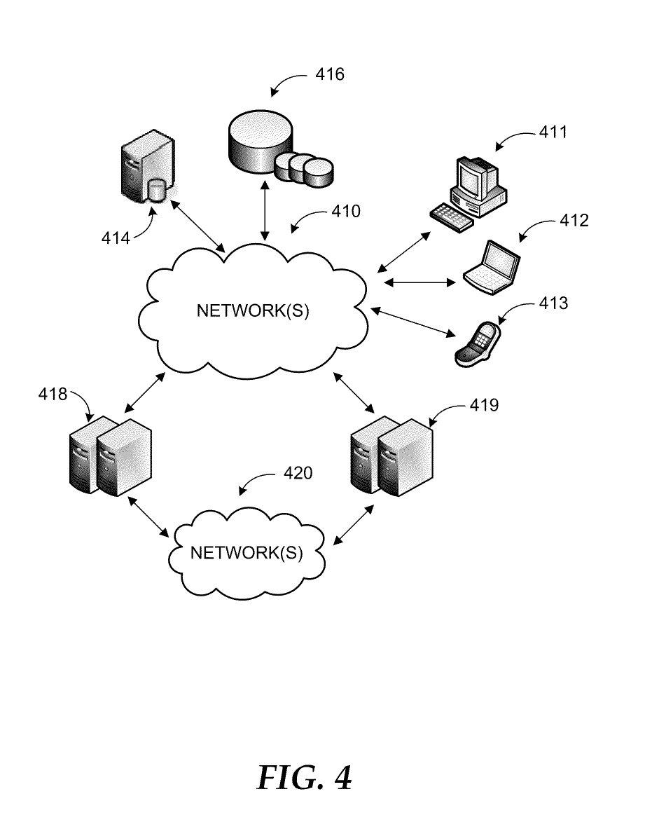

FIG. 4 is an example networked environment, where embodiments may be implemented. An extended security assertions language capable of enabling data handling preference and policy evaluation through queries and assertions may be implemented via software executed over one or more servers 418 such as a hosted service. The server 418 may communicate with client applications on individual computing devices such as a smart phone 413, a laptop computer 412, and desktop computer 411 (client devices) through network(s) 410. Client applications on client devices 411-413 may facilitate user interactions with the service executed on server(s) 418 enabling a user to request particular services and provide personal data associated with the requested service(s). The preference—policy matching evaluations discussed above may also be implemented by the client applications or user agents associated with the client applications. Furthermore, the service executed on server(s) 418 may interact with another service executed on server(s) 419 in providing a portion of the user requested services. Server(s) 418 and 419 may communicate through network(s) 410 and/or network(s) 420. At least a portion of the preference—policy matching evaluations discussed above may further be implemented by the service(s) executed on server(s) 419.

Data associated with the operations such as user personal data may be stored in one or more data stores (e.g. data store 416), which may be managed by any one of the server(s) 418, 419 or by database server 414. Personal data handling policy evaluation according to embodiments may be triggered when the data is used by a user agent or sent to a third party as discussed in the above examples. However, such an evaluation may also be enforced by a database storing personal data. For example, database server 414 may enforce the verification of attached policy before allowing a specific action (e.g. read) on the personal data stored in any of the data stores managed by the database server 414.

Network(s) 410 may comprise any topology of servers, clients, Internet service providers, and communication media. A system according to embodiments may have a static or dynamic topology. Network(s) 410 may include a secure network such as an enterprise network, an unsecure network such as a wireless open network, or the Internet. Network(s) 410 provides communication between the nodes described herein. By way of example, and not limitation, network(s) 410 may include wireless media such as acoustic, RF, infrared and other wireless media.

Many other configurations of computing devices, applications, data sources, and data distribution systems may be employed to implement a system for evaluating user preferences against service policies according to embodiments. Furthermore, the networked environments discussed in FIG. 4 are for illustration purposes only. Embodiments are not limited to the example applications, modules, or processes.

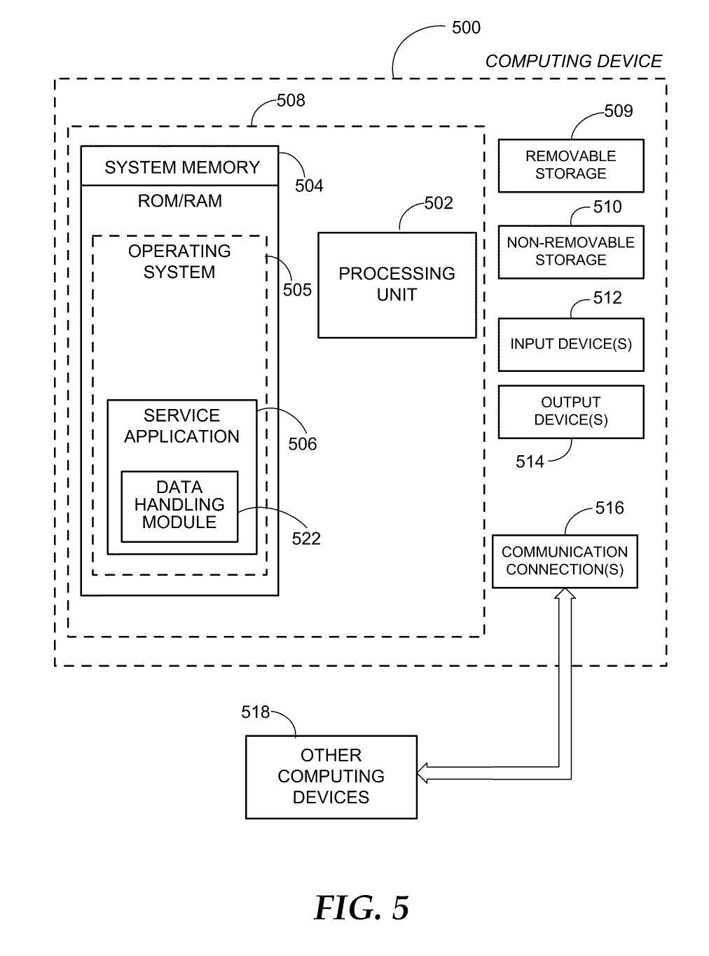

FIG. 5 and the associated discussion are intended to provide a brief, general description of a suitable computing environment in which embodiments may be implemented. With reference to FIG. 5, a block diagram of an example computing operating environment for a service application according to embodiments is illustrated, such as computing device 500. In a basic configuration, computing device 500 may be a server in a hosted service system and include at least one processing unit 502 and system memory 504. Computing device 500 may also include a plurality of processing units that cooperate in executing programs. Depending on the exact configuration and type of computing device, the system memory 504 may be volatile (such as RAM), non-volatile (such as ROM, flash memory, etc.) or some combination of the two. System memory 504 typically includes an operating system 505 suitable for controlling the operation of the platform, such as the WINDOWS® operating systems from MICROSOFT CORPORATION of Redmond, Wash. The system memory 504 may also include one or more software applications such as service application 506 and data handling module 522.

Data handling module 522 may be a separate application or an integral module of a hosted service that handles user data as discussed above. Evaluation of user preferences and service policies may be performed by utilizing queries based on preference and policy assertions. This basic configuration is illustrated in FIG. 5 by those components within dashed line 508.

Computing device 500 may have additional features or functionality. For example, the computing device 500 may also include additional data storage devices (removable and/or non-removable) such as, for example, magnetic disks, optical disks, or tape. Such additional storage is illustrated in FIG. 5 by removable storage 509 and non-removable storage 510. Computer readable storage media may include volatile and nonvolatile, removable and non-removable media implemented in any method or technology for storage of information, such as computer readable instructions, data structures, program modules, or other data. System memory 504, removable storage 509 and non-removable storage 510 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer readable storage media may be part of computing device 500. Computing device 500 may also have input device(s) 512 such as keyboard, mouse, pen, voice input device, touch input device, and comparable input devices. Output device(s) 514 such as a display, speakers, printer, and other types of output devices may also be included. These devices are well known in the art and need not be discussed at length here.

Computing device 500 may also contain communication connections 516 that allow the device to communicate with other devices 518, such as over a wireless network in a distributed computing environment, a satellite link, a cellular link, and comparable mechanisms. Other devices 518 may include computer device(s) that execute applications enabling users to input new data/requests, modify existing data/requests, and comparable operations. Communication connection(s) 516 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

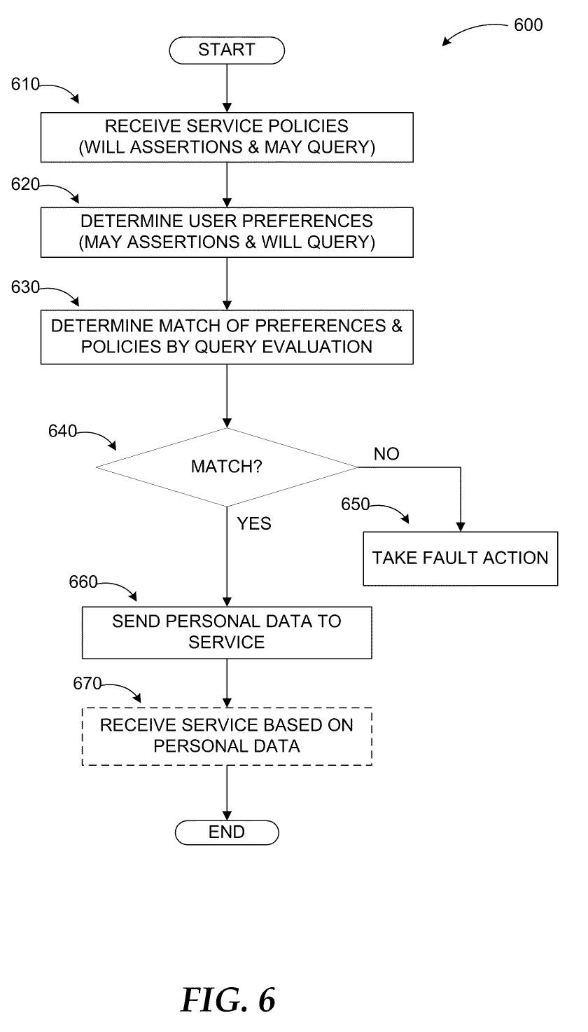

FIG. 6 illustrates a logic flow diagram of process 600 for handling personal data based on user preferences and service policies according to embodiments. Process 600 may be implemented at a client application capable of executing a verification algorithm for interacting with a service such as the ones described previously.

Process 600 begins with operation 610, where service policies are received at as will assertions and a may query in response to a request from a service. At operation 620, user preferences may be determined in form of may assertions and as a will query as described previously. The user may provide input for the preferences manually, or the preferences may be stored on the user's client application.

At operation 630, user preferences and service policies may be compared by the verification algorithm to determine a match employing query evaluation. If no match is determined at decision operation 640, a fault action (e.g. notifying the user about the mismatch or cancelling the transactions) may be performed at operation 650. If a match is determined, the personal data may be sent to the service at operation 660. Subsequently, the service may perform actions on the personal data. The actions on personal data may include sending the personal data to a third party, using the personal data for a service, modifying or deleting a portion of the personal data, or comparable actions. If the actions include a service being provided based on the personal data, the user may receive the service at optional operation 670.

The operations included in process 600 are for illustration purposes. User data handling through evaluation of user preference and service policies may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed at least in part in a computing device for evaluating user preferences and service policies in handling personal data, the method comprising:
determining user preferences as a set of “may” assertions and a “will” query;
receiving a service policy as a set of “will” assertions and a “may” query;
determining whether the service policy matches the user preferences employing a query evaluation; and
transferring the personal data if there is a match.

2. The method of claim 1, wherein the set of “may” assertions specify an upper bound for a service behavior and the “will” query specifies a lower bound for the service behavior as defined by the user preferences.

3. The method of claim 1, wherein the set of “will” assertions specify a lower bound for a service behavior and the “may” query specifies an upper bound for the service behavior regarding the personal data as defined by the service policy.

4. The method of claim 1, wherein the user preferences are further defined by at least one auxiliary assertion expressing delegation of authority in relation to handling of personal data.

5. The method of claim 1, wherein a portion of the assertions include conditions that depend on other assertions.

6. The method of claim 1, wherein determining whether the service policy matches the user preferences includes:
determining whether an upper bound specified in the service policy is contained within another upper bound specified in the user preferences; and
determining whether a lower bound specified in the user preferences is contained within another lower bound specified in the service policy.

7. The method of claim 1, further comprising:
parameterizing the user preferences and the service policy by employing placeholders for identifying user and service;
instantiating the placeholders prior to determining whether the service policy matches the user preferences.

8. The method of claim 7, further comprising:
receiving another service policy associated with an additional service;
determining whether the other service policy matches the user preferences and the service policy of the service employing a query evaluation and re-instantiating the placeholders in context of forwarding the personal data to the other service.

9. The method of claim 8, further comprising:
retaining the original, uninstantiated user preferences and the personal data at the service for evaluations and forwarding of the personal data to further services from the service.

10. The method of claim 1, further comprising:
sending a portion of the user preferences to the service along with the personal data such that a dynamic sticky policy is created at the service customized for the user.

11. The method of claim 1, further comprising:
in response to determining at least one non-matching user preference and the service policy, terminating further handling of personal data, determining at least one available solution, and notifying the user regarding the non-match and the at least one available solution, wherein the at least one available solution includes at least one from a set of: modification of the non-matching user preference and modification of the service policy.

12. A system for evaluating user preferences and service policies in handling personal data, the system comprising:
a server executing a data collection service for collecting personal data configured to:
receive a request for a service policy from a user;
retrieve the service policy as a set of “will” assertions specifying a lower bound for a service behavior regarding the personal data and a “may” query specifying a lower bound for the service behavior;
send the service policy to the user determine whether the service policy matches user preferences defined as a set of “may” assertions specifying an upper bound for a service behavior and a “will” query specifying a lower bound for the service behavior, wherein a match is determined by evaluating the queries against a union of the user preference and service policy assertions; and
receive the personal data from the user if there is a match, else terminate further handling of any received personal data, delete already received personal data, and notify the user regarding non-match.

13. The system of claim 12, wherein the server is further configured to:
in response to determining a need to alter the service policy, modify an applicable one of the “will” assertions and the “may” query to reflect new behaviors associated with the altered service policy; and
re-evaluate the queries against a union of the user preference assertions and the modified service policy assertions.

14. The system of claim 12, wherein the service employs at least one protocol for exchanging and handling personal data that is formalized in terms of runs of a bundle of services, and wherein each run includes a linear sequence of states, each a state indicating personal data already collected by the server, and a service policy and a user preference associated with the collected personal data.

15. The system of claim 12, comprising a second server configured to execute another service for receiving the personal data, wherein the data collection service discloses the personal data to the other service if the service policy permits the disclosure and the other service's policy matches the user preferences.

16. The system of claim 15, wherein a trust model is employed to determine which of the data collection service and the other service is to evaluate whether the other service's policy matches the user preferences.

17. A computer-readable storage medium with instructions stored thereon for evaluating user preferences and service policies in handling personal data, the instructions comprising:
determining user preferences as a set of “may” assertions specifying permitted behaviors for a service and a “will” query specifying obligations for the service;
receiving a service policy as a set of “will” assertions specifying promised behavior by the service regarding the personal data and a “may” query specifying possible relevant behaviors of the service regarding the personal data;
determining whether the service policy matches the user preferences by evaluating the queries at a verification module against a union of the user preference assertions and service policy assertions; and
transferring the personal data to the service if there is a match, else terminating further handling of any received personal data, deleting already received personal data, and notifying the user regarding non-match.

18. The computer-readable storage medium of claim 17, wherein the verification module is executed on one of: a client device associated with the user, a server executing the service, and a third party server.

19. The computer-readable storage medium of claim 17, wherein the “will” query is a query in which no sub-query of the form (S says S will b?) occurs in scope of a negation sign and the “may” query is a query in which no sub-query of the form (U says S may b?) occurs in one of: a disjunction, a scope of an existential quantifier, and a scope of a negation sign.

20. The computer-readable storage medium of claim 17, wherein the user preferences specify at least one from a set of: a type of personal data permitted to be collected by the service, a type of personal data permitted to be stored by the service, a type of personal data permitted to be shared by the service, a permitted duration of storage for the personal data, and a purpose for usage of the personal data.
